(19) United States
(12) Patent Application Publication
(10) Pub. No.: US 2024/0110857 A1
(43) Pub. Date: Apr. 4, 2024

(54) LIQUID FLOW CHARGING DEVICE AND FLOW CELL

(71) Applicant: BECKMAN COULTER BIOTECHNOLOGY (SUZHOU) CO., LTD., Suzhou, Jiangsu (CN)

(72) Inventors: Ruifeng MIAO, Suzhou, Jiangsu (CN); Wei SHI, Suzhou, Jiangsu (CN); Jingzhang WU, Suzhou, Jiangsu (CN)

(73) Assignee: BECKMAN COULTER BIOTECHNOLOGY (SUZHOU) CO., LTD., Suzhou, Jiangsu (CN)

(21) Appl. No.: 18/262,544

(22) PCT Filed: Nov. 1, 2021
(86) PCT No.: PCT/CN2021/127870

§ 371 Date: Jul. 21, 2023

(30) Foreign Application Priority Data
Jan. 22, 2021 (CN) 202120180099.3

(51) Int. Cl. G01N 15/14

(52) U.S. Cl. CPC G01N 15/1404; G01N 15/149

(57) ABSTRACT

The present disclosure relates to a liquid flow charging device for a flow cell and a flow cell comprising the liquid flow charging device. The liquid flow charging device comprises a first electrode and a second electrode. The first electrode is electrically connected to a liquid flow flowing through a flow channel assembly of the flow cell. The second electrode is located at a predetermined position on a radially outer side of the liquid flow and has a cylindrical inner peripheral surface surrounding the liquid flow. The liquid flow charging device has improved charging efficiency, stable charging performance, and enhanced safety.

### TECHNICAL FIELD

The present disclosure relates to a liquid flow charging device for a flow cell and a flow cell including the liquid flow charging device, for example, a flow cell of a flow cytometer.

### RELATED ART

The content in this section only provides background information related to the present disclosure, which does not necessarily constitute the prior art.

Flow sorters are often used for analyzing and sorting samples such as microsomes or cells. A flow sorter includes a flow cell, and samples and a sheath fluid converge in a flow channel assembly of the flow cell and are ejected through a nozzle of the flow channel assembly. An ejected liquid flow of the samples and sheath fluid needs to be charged just before it is separated into droplets. In this way, the separated droplets are charged, and the charged droplets are deflected when passing through a high-voltage electric field generated between deflection plates, thereby sorting the droplets containing the samples.

A charging electrode of the liquid flow charging device of the existing flow cell directly contacts with a sheath fluid flow, so that the sheath fluid flow is in a charged state. In this case, in order to ensure safety, parts of each component in contact with the sheath fluid flow need to be insulated, so the design of the flow cell becomes complicated and the manufacturing difficulty is increased. Because the sheath fluid is charged, the liquid flow charging device has a relatively large charging power and a relatively complicated structure.

### SUMMARY

This section provides a general summary of the present disclosure, rather than a comprehensive disclosure of the full scope of the present disclosure or all features of the present disclosure.

An objective of the present disclosure is to provide a liquid flow charging device for a flow cell that can alleviate or eliminate at least part of the above problems.

Another objective of the present disclosure is to provide a flow cell, which includes a liquid flow charging device that has a simplified structure and can stably charge a liquid flow.

According to an aspect of the present disclosure, a liquid flow charging device for a flow cell is provided. The liquid flow charging device includes a first electrode and a second electrode. The first electrode is electrically connected to a liquid flow flowing through a flow channel assembly of the flow cell. The second electrode is located at a predetermined position on a radially outer side of the liquid flow and has a cylindrical inner peripheral surface surrounding the liquid flow.

The liquid flow charging device according to the present disclosure has a cylindrical inner peripheral surface, and thus has an increased electrode area, thereby improving the charging efficiency and making the charging performance more stable.

In some examples according to the present disclosure, the first electrode is grounded, and the second electrode is electrically connected to a charging control device. The second electrode is not in direct contact with the liquid flow, so conductivity or safety requirements of all parts in contact with droplets can be reduced, thus simplifying structures of the parts.

In some examples according to the present disclosure, the first electrode is made of an inert metal material, or an inert metal layer is arranged on a conductive metal layer. For example, the first electrode is made of a gold material, or a gold-plated layer is arranged on the conductive metal layer. The inert metal material or the inert metal layer can protect the first electrode from oxidation or corrosion.

In some examples according to the present disclosure, a hole for a light beam to pass through is arranged on a side wall of the second electrode. Optionally, the hole has an elongated shape in a flow direction of the liquid flow. In the case of ensuring the electrode area, the structure can be changed as needed to facilitate the operation of the flow cell.

In some examples according to the present disclosure, the second electrode includes a conductive metal layer and a protective layer located on a surface of the conductive metal layer. For example, the protective layer includes an oxide layer, a non-metal layer, and/or an insulating layer. The protective layer can provide protection for the second electrode, for example, to avoid oxidation or corrosion, to prevent the risk of electric shock, and so on.

In another aspect according to the present disclosure, a flow cell including the above liquid flow charging device is provided. The flow cell may have the same technical effects as the above liquid flow charging device.

In some examples according to the present disclosure, the first electrode is located in a debubbling port of a flow channel assembly of the flow cell. The first electrode is electrically connected to a ground terminal of a casing of the flow cell.

In some examples according to the present disclosure, the second electrode is electrically connected to a charging control device via a spring. A flexible electrical connection can be provided by the spring.

In some examples according to the present disclosure, the flow cell further includes a fixing member for accommodating, installing, or fixing the second electrode, and a protective layer is arranged on a surface of the fixing member. For example, the protective layer of the fixing member includes an insulating layer. It is only necessary that the fixing member in contact with the second electrode is provided with a protective layer, and therefore, the safety of the entire flow cell can be improved with a simple structure.

### BRIEF DESCRIPTION OF THE DRAWINGS

Through the following description with reference to accompanying drawings, the features and advantages of one or more embodiments of the present disclosure will become easier to understand, and in the accompanying drawings:

FIG. 1 is a schematic three-dimensional diagram of a flow cell according to an embodiment of the present disclosure;

FIG. 2 is a schematic cross-sectional view of the flow cell of FIG. 1;

FIG. 3 is a schematic diagram of a charging device according to an embodiment of the present disclosure;

FIG. 4 shows an example of a charging electrode according to an embodiment of the present disclosure; and

FIG. 5 is a schematic diagram of a fixing member for installing a charging electrode according to an embodiment of the present disclosure.

### DETAILED DESCRIPTION

The present disclosure will be described below in detail through example embodiments with reference to the accompanying drawings. In the several accompanying drawings, similar reference numerals indicate similar parts and components. The following detailed description of the present disclosure is for illustrative purposes only, and is by no means limiting the present disclosure and its applications or uses. The embodiments described in this specification are not exhaustive, but are only some of several possible embodiments. The example embodiments may be implemented in many different forms, and should not be construed as limiting the scope of the present disclosure. In some example embodiments, well-known processes, well-known device structures, and well-known technologies may not be described in detail.

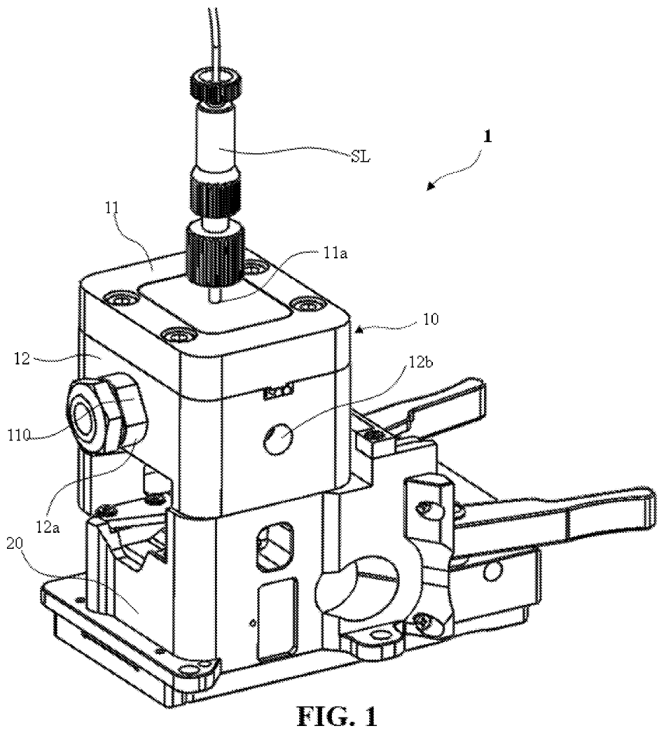

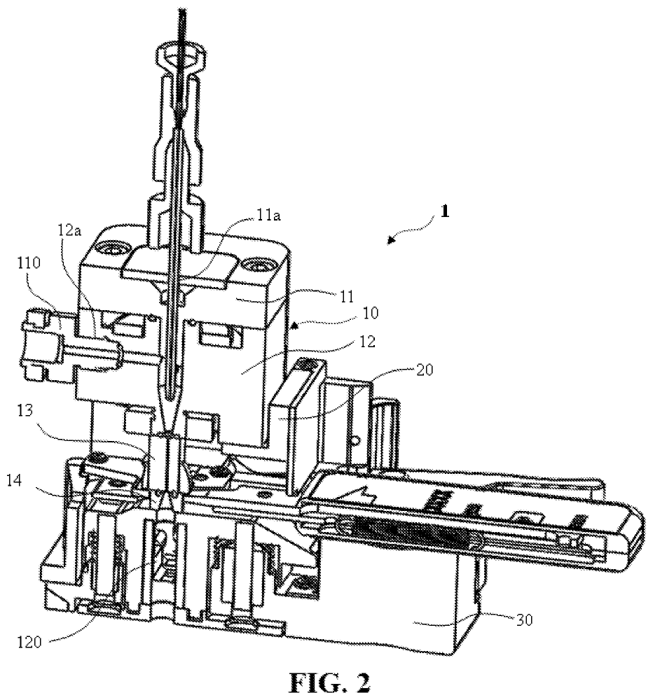

FIG. 1 is a schematic three-dimensional diagram of flow cell 1 according to an embodiment of the present disclosure. FIG. 2 is a schematic cross-sectional view of flow cell 1 in FIG. 1. The structure of flow cell 1 will be described below with reference to FIG. 1 and FIG. 2. An instrument such as a flow sorter is an instrument that sorts samples by detecting physical or chemical properties of the samples. The sorted samples may include cells, chromosomes, and the like of an organism. Flow cell 1 is generally an important part of an instrument such as a flow sorter, and is configured to allow various processing fluids and samples to be converged therein and discharged therefrom.

As shown in FIG. 1 and FIG. 2, flow cell 1 includes flow channel assembly 10 and frame 20 configured to support or install flow channel assembly 10. A sheath fluid and samples are converged in flow channel assembly 10 via respective ports, and then ejected in a predetermined mode (such as a mode of single row arrangement) via a nozzle, so as to sort the samples.

Flow channel assembly 10 includes top cover 11, flow channel main body 12, glass cell 13, and nozzle 14.

Top cover 11 covers a top surface of flow channel main body 12, and is provided with sample port 11a for introducing a sample. Sample line SL is connected to sample port 11a to supply the samples into flow channel main body 12.

Flow channel main body 12 is provided with debubbling port 12a and sheath fluid port 12b. The sheath fluid may be supplied into flow channel main body 12 via sheath fluid port 12b. Debubbling port 12a is connected to a vacuum device (not shown), and therefore, the fluid in flow channel main body 12 can be drawn out under vacuum for debubbling. The sheath fluid supplied into flow channel main body 12 converges with the samples, and the samples are wrapped in the sheath fluid.

Glass cell 13 is located on an outlet side of flow channel main body 12. Glass cell 13 is an element capable of transmitting light, and may also be referred to as an optical element. When the samples pass through glass cell 13, physical or chemical properties of the samples may be detected by means of an optical device (not shown). Glass cell 13 may be an optional element according to needs.

Nozzle 14 is located on an outlet side of glass cell 13 and is configured to eject samples in, for example, the single row arrangement. The ejected liquid flow (including the sheath fluid and the samples) is gradually separated into droplets under the action of an oscillator. Usually, each droplet contains a sample in order to sort the sample. The ejected liquid flow is charged when it is about to be separated into the droplets, so that the charged droplets are deflected when passing through a high-voltage electric field and fall into corresponding containers, thus realizing the sorting. To this end, flow cell 1 further includes a liquid flow charging device for charging the liquid flow ejected from nozzle 14.

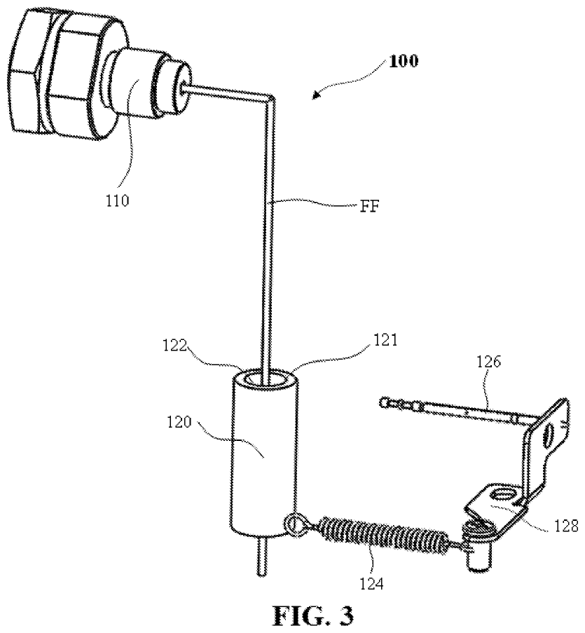

FIG. 3 is a schematic diagram of liquid flow charging device 100 according to an embodiment of the present disclosure. Liquid flow charging device 100 will be described below with reference to FIG. 3.

As shown in FIG. 3, liquid flow charging device 100 includes first electrode 110 and second electrode 120. First electrode 110 is electrically connected to a liquid flow FF flowing through flow channel assembly 10. Second electrode 120 is located on a radially outer side of the liquid flow FF, thereby forming a capacitive charging device.

Referring to FIG. 1 and FIG. 2, first electrode 110 may be arranged in debubbling port 12a so that first electrode 110 may in direct contact with the sheath fluid in flow channel main body 12. That is, first electrode 110 may be electrically connected to the sheath fluid in flow channel main body 12.

First electrode 110 may be grounded, and therefore is sometimes referred to as a cathode plate. For example, first electrode 110 is electrically connected to a ground terminal of a casing (not shown) of flow cell 1. In this way, first electrode 110 may be made of an inert metal material, thereby preventing oxidation or corrosion from occurring. An example of an inert metal material is a gold material. Alternatively, first electrode 110 may be made of a conductive metal material, and gold is plated on the conductive metal material. That is, first electrode 110 includes a conductive metal layer and a gold-plated layer located on a surface of the conductive metal layer. The gold-plated layer can also avoid oxidation or corrosion well.

It should be understood that the structure and material of the first electrode according to the present disclosure are not limited to the specific examples illustrated and described herein, but can be changed according to actual needs.

Second electrode 120 is arranged under nozzle 14 and held by fixing member 30 (as shown in FIG. 2). Referring to FIG. 3, second electrode 120 has through hole 122 so that the liquid flow FF flows through hole 122. The size of through hole 122 (for example, a radial distance from the liquid flow FF) can be set according to factors such as splashing of droplets. Second electrode 120 has cylindrical inner peripheral surface 121. A capacitance generated between cylindrical inner peripheral surface 121 and the liquid flow FF is the largest, so that the charge amount of the droplets is maximized, that is, the charging efficiency is improved. As the charging efficiency is improved, a lower charging voltage can be used to meet the need of a droplet bias angle. This can better maintain the activity of the sample in the droplet.

In addition, the distance between cylindrical inner peripheral surface 121 and the liquid flow FF is constant, and therefore, the distance between second electrode 120 and the liquid flow FF can be minimized in the case of avoiding droplets from splashing to second electrode 120, thereby further maximizing the charging capacitance.

Second electrode 120 is made of a metal material and is electrically connected to a charging control device (not shown), so it is sometimes referred to as an anode plate (may also be referred to as a charging plate). As shown in FIG. 3, second electrode 120 may be connected to the charging control device via spring 124, thereby achieving a flexible connection of the second electrode. Spring 124 may be connected to the charging control device via rigid conductive element 128 and pogo pin 126.

Spring 124 is a standard structural member and does not require customization, so the processing process can be simplified and the cost is lower. Spring 124 may be used to replace a wire to realize the electrical connection of second electrode 120. Spring 124 can be elastically deformed, so it can adapt to a position change between second electrode 120 and rigid conductive element 128, thereby reducing the relative position requirement between second electrode 120 and rigid conductive element 128. In addition, spring 124 is used as a structural member, so that the liquid flow charging device can be composed of conductive structural members without introducing electronic elements, making the design easier and simpler.

Through pogo pin 126, second electrode 120 and fixing member 30 can be advantageously inserted into and detached from frame 20. In addition, pogo pin 126 can ensure a reliable electrical contact.

It should be understood that the structure and material of the second electrode according to the present disclosure are not limited to the specific examples shown in FIG. 3 and described above, but can be changed according to actual needs. For example, the outer peripheral surface of second electrode 120 may vary according to its peripheral structure.

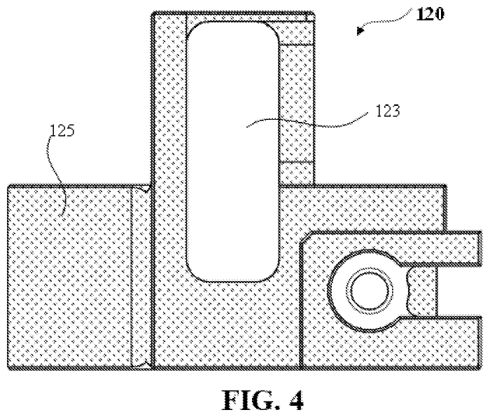

FIG. 4 shows an example of charging electrode 120 according to an embodiment of the present disclosure. As shown in FIG. 4, hole 123 for a light beam to pass through is arranged on a side wall of second electrode 120. Hole 123 may have an elongated shape in a flow direction of the liquid flow FF. The arrangement of hole 123 can facilitate the light beam to pass through to perform optical detection of the sample.

In addition to the conductive metal layer made of a metal material, second electrode 120 may further include protective layer 125 arranged on a surface of conductive metal layer. Protective layer 125 is configured to prevent second electrode plate 120 from being oxidized, being corroded, or electric shock risk, thereby improving charging stability and safety.

For example, protective layer 125 includes an oxide layer, a non-metal layer, and/or an insulating layer. Through protective layer 125, even if a salt solution such as the sheath fluid is splashed to second electrode 120, the conductive salt solution can be separated from the conductive metal layer of second electrode plate 120, thereby avoiding oxidation or corrosion.

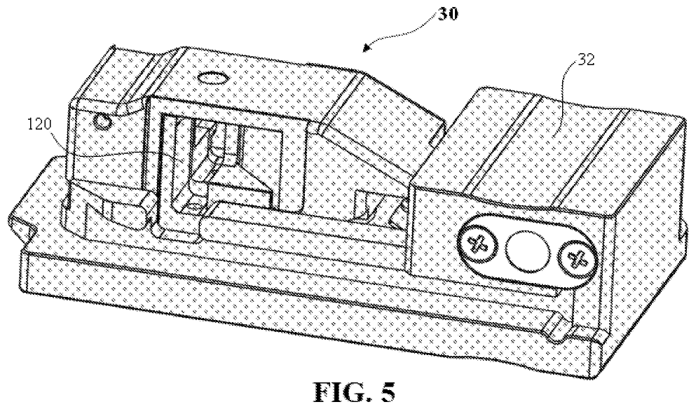

FIG. 5 is a schematic diagram of fixing member 30 for installing second electrode 120 according to an embodiment of the present disclosure. As shown in FIG. 5, second electrode 120 is accommodated, installed, or fixed in fixing member 30. Fixing member 30 can be inserted into frame 20 together with second electrode 120. Fixing member 30 is a part that is in directly contact with second electrode 120, and therefore, fixing member 30 may be made of a non-metal material. Alternatively, fixing member 30 may be made of a metal material, and protective layer 32, for example, an insulating layer or a non-metal material layer, is arranged on the entire surface of the metal material, thus improving the safety of entire flow cell 1.

Although the present disclosure has been described with reference to example embodiments, it should be understood that the present disclosure is not limited to the specific embodiments described and illustrated in the text. Without departing from the scope defined by the claims, those skilled in the art can make various changes to the example embodiments. Provided that there is no contradiction, features in the various embodiments can be combined with each other. Alternatively, a certain feature in the embodiment may also be omitted.

1. A liquid flow charging device for a flow cell, comprising:
a first electrode electrically connected to a liquid flow flowing through a flow channel assembly of the flow cell; and
a second electrode located at a predetermined position on a radially outer side of the liquid flow and has a cylindrical inner peripheral surface surrounding the liquid flow.

2. The liquid flow charging device according to claim 1, wherein the first electrode is grounded, and the second electrode is electrically connected to a charging control device.

3. The liquid flow charging device according to claim 2, wherein the first electrode is made of an inert metal material, or an inert metal layer is arranged on a conductive metal layer.

4. The liquid flow charging device according to claim 2, wherein the first electrode is made of a gold material, or a gold-plated layer is arranged on a conductive metal layer.

5. The liquid flow charging device according to claim 1, wherein a hole for a light beam to pass through is arranged on a side wall of the second electrode.

6. The liquid flow charging device according to claim 5, wherein the hole has an elongated shape in a flow direction of the liquid flow.

7. The liquid flow charging device according to claim 1, wherein the second electrode comprises a conductive metal layer and a protective layer located on a surface of the conductive metal layer.

8. The liquid flow charging device according to claim 7, wherein the protective layer comprises an oxide layer, a non-metal layer, and/or an insulating layer.

9. A flow cell, comprising the liquid flow charging device according to claim 1.

10. The flow cell according to claim 9, wherein the first electrode is located in a debubbling port of a flow channel assembly of the flow cell.

11. The flow cell according to claim 10, wherein the first electrode is electrically connected to a ground terminal of a casing of the flow cell.

12. The flow cell according to claim 9, wherein the second electrode is electrically connected to a charging control device via a spring and/or a pogo pin.

13. The flow cell according to claim 12, wherein the flow cell further comprises a fixing member for accommodating, installing, or fixing the second electrode, and the fixing member is made of a non-metal material, or a protective layer is arranged on a surface of the metal material.

14. The flow cell according to claim 13, wherein in the case that the fixing member has a protective layer, the protective layer comprises an insulating layer or a non-metal material layer.
